(19) United States
(12) Patent Application Publication
(10) Pub. No.: US 2017/0018845 A1
(43) Pub. Date: Jan. 19, 2017

(54) ANTENNA APPARATUS

(71) Applicant: Samsung Electro-Mechanics Co., Ltd., Suwon-si (KR)

(72) Inventors: Ho Jin LEE, Suwon-si (KR); Jong Yun KIM, Suwon-si (KR)

(73) Assignee: Samsung Electro-Mechanics Co., Ltd., Suwon-si (KR)

(21) Appl. No.: 15/137,513

(22) Filed: Apr. 25, 2016

(30) Foreign Application Priority Data
Jul. 17, 2015 (KR) 10-2015-0101713
Mar. 25, 2016 (KR) 10-2016-0036123

(51) Int. Cl. H01Q 1/36; H01Q 5/10; H01Q 1/48

(52) U.S. Cl. CPC H01Q 1/36; H01Q 1/48; H01Q 5/10

(57) ABSTRACT

An antenna apparatus includes: a first antenna part configured to transmit and receive signals in a first frequency band; a coupling part connected to the first antenna part; and a second antenna part connected to the coupling part and configured to transmit and receive signals in a second frequency band different from the first frequency band, wherein the second antenna part encloses surfaces of a three-dimensional shape together with the first antenna part and the coupling part.

### CROSS-REFERENCE TO RELATED APPLICATION(S)

This application claims the benefit under 35 U.S.C. §119(a) of Korean Patent Application Nos. 10-2015-0101713 filed on Jul. 17, 2015 and 10-2016-0036123 filed on Mar. 25, 2016 in the Korean Intellectual Property Office, the entire disclosure of which is incorporated herein by reference for all purposes.

### BACKGROUND

1. Field

The following description relates to an antenna apparatus.

2. Description of Related Art

Transmitting and receiving data is performed in various devices such as home appliances, vehicles, and the like, as well as in computers or communications devices. Therefore, performance, a radiation pattern, volume, compatibility, and the like, of an antenna apparatus transmitting and receiving data has become important.

As an antenna for a wireless local area network (WLAN) according to the related art, an external dipole type antenna has been mainly adopted and used in a case in which no restriction is present in an antenna volume condition depending on a structure and a condition of a set. In addition, in a case in which the antenna for a WLAN according to the related art is mounted in a set and installed in a narrow space depending on a spatial margin and design demand, an antenna printed on a printed circuit board (PCB) has been used as the antenna for a WLAN according to the related art.

The external dipole type antenna is good in terms of performance and a radiation pattern. However, since the external dipole type antenna should be installed outside of the set, it occupies a large volume. The antenna printed on the printed circuit board has minimum performance and has a volume smaller than those of other types of antennas. However, since the antenna printed on the printed circuit board has a planar structure, performance and sensitivity of the antenna appear in only a specific direction. For example, the antenna printed on the printed circuit board may smoothly transmit and receive signals in a direction in which it is directed, but may not generally smoothly transmit and receive signals in a lateral direction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, an antenna apparatus includes a first antenna part configured to transmit and receive signals in a first frequency band; a coupling part connected to the first antenna part; and a second antenna part connected to the coupling part and configured to transmit and receive signals in a second frequency band different from the first frequency band, wherein the second antenna part encloses surfaces of a three-dimensional shape together with the first antenna part and the coupling part.

The second antenna part may be disposed on one surface of the three-dimensional shape, and the coupling part may enclose one surface of the three-dimensional shape, two surfaces of the three-dimensional shape adjacent to the one surface, and a surface of the three-dimensional shape opposing the one surface.

The first antenna part may enclose the one surface of the three-dimensional shape, one of the two surfaces of the three-dimensional shape adjacent to the one surface, and the surface of the three-dimensional shape opposing the one surface.

The first antenna part may be disposed on one of the two surfaces of the three-dimensional shape adjacent to the one surface and has an area smaller than that of the coupling part.

The antenna apparatus may further include: a feeding portion configured to provide signals to the first antenna part and the second antenna part; and a ground portion configured to provide a ground to the first antenna part and the second antenna part.

One of the feeding portion and the ground portion may contact the second antenna part, and the other thereof may contact the coupling part.

According to another general aspect, a substrate module includes a substrate; and an antenna apparatus disposed on the substrate, wherein the antenna apparatus includes: a coupling part having a folded shape to enclose surfaces of a three-dimensional shape and contacting the substrate; a first antenna part connected to the coupling part, spaced apart from the substrate, and configured to transmit and receive signals in a first frequency band; and a second antenna part connected to the coupling part, spaced apart from the substrate, and configured to transmit and receive signals in a second frequency band different from the first frequency band.

The first antenna part may be perpendicular to the substrate, and the second antenna part may be in parallel with the substrate.

The coupling part may have first and second protrusion regions, the first protrusion region may be connected to the first antenna part, and the second protrusion region may be connected to a ground portion.

The second antenna part may be disposed between the first and second protrusion regions, and a feeding portion may be connected to the second antenna part.

The substrate module may further include: a feeding portion configured to provide signals to the first antenna part and the second antenna part; and a ground portion configured to provide a ground to the first antenna part and the second antenna part, one of the feeding portion and the ground portion contacting the second antenna part and the other thereof contacting the coupling part.

The feeding portion and the ground portion may be electrically connected to the substrate, and the substrate may provide the signals and the ground to the first and second antenna parts.

The substrate may include a metal layer spaced apart from the antenna apparatus, and an electric potential of the metal layer may be the same as that of the coupling part.

The substrate module may further include a metal structure disposed on the substrate, and an electric potential of the metal structure may be the same as that of the coupling part.

The substrate module may further include a second antenna apparatus disposed on the substrate, and the second antenna apparatus may have a structure symmetrical to the antenna apparatus.

According to another general aspect, a multi-band antenna includes: a substantially planar conductive member configured to be folded on an axis, the planar conductive member comprising: a coupling part disposed in first to third regions; a first antenna part disposed in a fourth region and connected to the coupling part; and a second antenna part disposed in the third region and connected to the coupling part, the first region and the second region are connected to each other while having a linear boundary therebetween, the second region and the third region are connected to each other while having a linear boundary therebetween, and the third region and the fourth region are connected to each other while having a linear boundary therebetween.

The substantially planar conductive member may be configured to be folded on three substantially parallel axes to form a 3-dimensional antenna member.

The second antenna part may be configured to radiate in a substantially axial direction, the first antenna part may be configured to radiate in a lateral direction, and the first operational frequency may be different from the second operational frequency.

The coupling part may be configured to electrically connect the first antenna part with the second antenna part and to electromagnetically couple with the first antenna part and/or the second antenna part to collectively generate a radiation pattern.

Other features and aspects will be apparent from the following detailed description, the drawings, and the claims.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a conceptual diagram illustrating an antenna apparatus according to an embodiment.

FIG. 2 is a view illustrating the antenna apparatus of FIG. 1 in more detail.

FIG. 3 is a view illustrating a state in which the antenna apparatus of FIG. 2 is formed in a three-dimensional structure.

FIG. 4 is a view illustrating the antenna apparatus of FIG. 1 in more detail.

FIG. 5 is a view illustrating a state in which the antenna apparatus of FIG. 4 is formed in a three-dimensional structure.

FIG. 6 is a view illustrating the antenna apparatus of FIG. 1 in more detail.

FIG. 7 is a view illustrating a state in which the antenna apparatus of FIG. 6 is formed as a three-dimensional structure.

FIG. 8 is a view illustrating a substrate module in which the antenna apparatus of FIG. 7 is disposed.

FIGS. 9A and 9B are graphs illustrating efficiencies of the antenna apparatus according to an embodiment depending on frequencies.

FIG. 10 is a view illustrating an operating environment of the antenna apparatus according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the example embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views. In the drawings, for example, due to manufacturing techniques and/or tolerances, modifications of the shape shown may be encountered. Thus, embodiments should not be construed as being limited to the particular shapes of regions shown herein, but should be construed broadly, to include for example, a change in shape resulting from manufacturing. The following embodiments may also be constituted by one or a combination thereof.

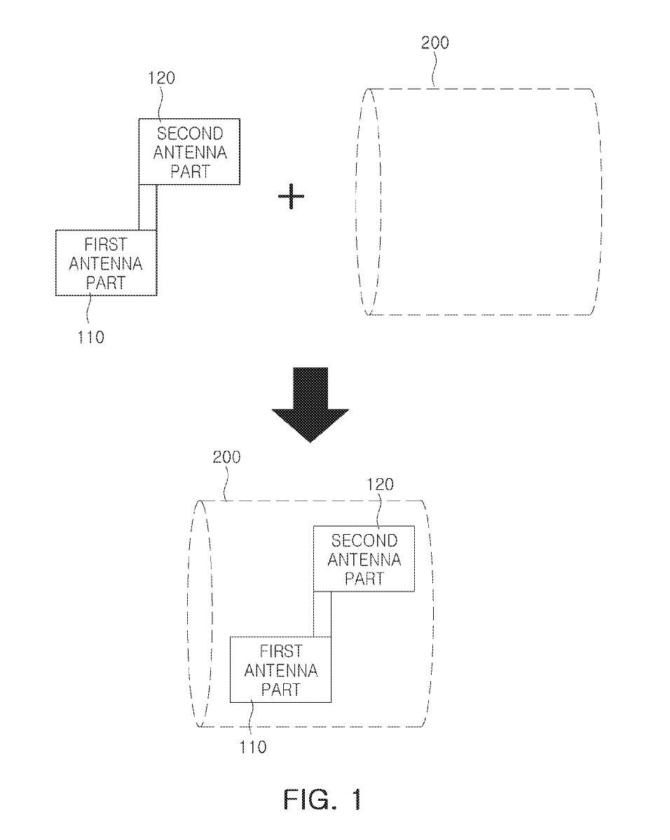

FIG. 1 is a view illustrating an antenna apparatus according to an embodiment.

Referring to FIG. 1, the antenna apparatus includes a first antenna part 110 and a second antenna part 120. That is, the antenna apparatus may include a plurality of antennas.

The first antenna part 110 and the second antenna part 120 are connected to each other to transmit and receive signals between each other. Here, the second antenna part 120 is disposed together with the first antenna part 110 on a surface of a three-dimensional shape 200 to form a three-dimensional antenna structure.

For example, the first antenna part 110 and the second antenna part 120 are manufactured in a two-dimensional planar form and folded three-dimensionally according to the three-dimensional shape 200. The first antenna part 110 and the second antenna part 120 having the two-dimensional planar form may be a development figure for a three-dimensional structure.

Thereby, the first antenna part 110 and the second antenna part 120 transmit and receive signals in different directions in relation to the three-dimensional shape 200. That is, the first antenna part 110 and the second antenna part 120 supplement radiation directions with each other to provide a plurality of transversely radiated axes.

In addition, the first antenna part 110 may primarily transmit and receive signals in a first band, and the second antenna part 120 may primarily transmit and receive signals in a second band different from the first band. That is, the antenna apparatus according to an embodiment may transmit and receive signals in a plurality of frequency bands. For example, the first band is a band of about 2.4 GHz, and the second band is a band of about 5 GHz.

Generally, radiation patterns of antennas may be changed depending on frequency bands of transmitted and received signals. In addition, one of the signals in the plurality of frequency bands may interfere with another thereof. For example, a radiation pattern for the signals in the first band is different from that for the signals in the second band, and may interfere with the signals in the second band.

Therefore, directions in which desired radiation patterns are formed may also be changed depending on frequency bands of transmitted and received signals. For example, the signals in the first band should be strongly transmitted and received with respect to an xy plane, and the signals in the second band should be strongly transmitted and received in a z direction.

Due to the antenna apparatus, according to an embodiment, having the three-dimensional structure, directions of radiation patterns of the first antenna part 110 and the second antenna part 120 may be freely determined. In addition, the first and second antenna parts 110 and 120 are formed so that interference between the signals transmitted and received by the first antenna part 110 and the signals transmitted and received by the second antenna part 120 are reduced or harnessed for selective constructive/destructive interference.

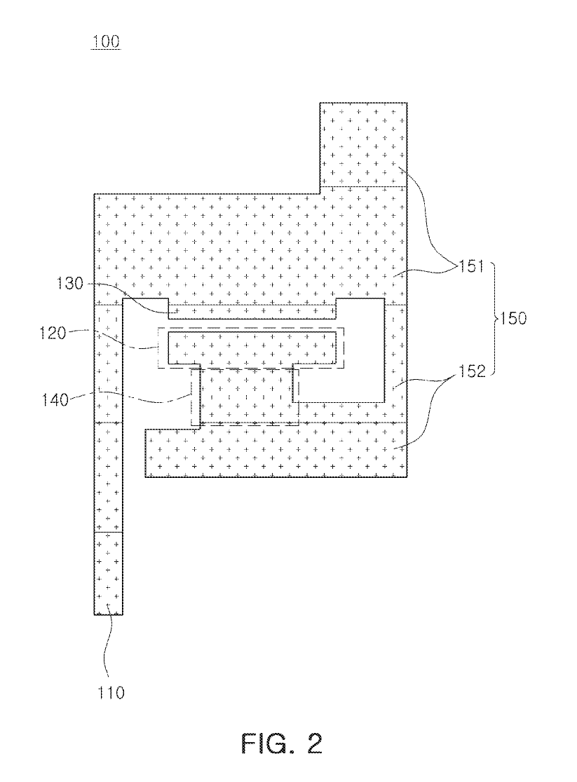

FIG. 2 is a view illustrating the antenna apparatus of FIG. 1 in more detail.

Referring to FIG. 2, the antenna apparatus 100 includes the first antenna part 110 and the second antenna part 120, and further includes a feeding portion 130, a ground portion 140, and a coupling part 150.

The first antenna part 110 has an aperture form enclosing side surfaces of the three-dimensional shape 200, and the second antenna part 120 has a dipole form disposed on one side surface of the three-dimensional shape 200. That is, the antenna apparatus 100 includes a plurality of heterogeneous antennas.

In addition, the three-dimensional shape 200 is a tube shape. Here, the tube shape includes a polyhedral bar shape such as a cylindrical shape, or a hexahedral shape, etc., though any suitable shape may be employed.

Generally, radiation patterns of antennas change depending on a form of the antenna. For example, an antenna having an aperture form transmits and receives signals in a surface direction, and an antenna having a dipole form transmits and receives signals in a length direction. In addition, one antenna is disposed so that its form matches that of another antenna. Therefore, a plurality of antennas having different forms occupy a volume relatively smaller than a volume occupied by a plurality of antennas having the same form.

The antenna apparatus 100 according to an embodiment is disposed with respect to the three-dimensional shape 200 in consideration of forms and directions of the antennas, and thus signals may be transmitted and received in an omni-directional pattern, and a volume occupied by the antennas is reduced.

The feeding portion 130 transfers signals to and from the first antenna part 110 and the second antenna part 120. The ground portion 140 provides a ground to the first antenna part 110 and the second antenna part 120. For example, the feeding portion 130 and/or the ground portion 140 are connected to a cable through soldering.

For example, in a case in which one of the feeding portion 130 and the ground portion 140 are disposed to be electrically adjacent to one of the first antenna part 110 and the second antenna part 120, the other of the feeding portion 130 and the ground portion 140 is disposed to be electrically adjacent to the other of the first antenna part 110 and the second antenna part 120. That is, each of the feeding portion 130 and the ground portion 140 are disposed to correspond to the first antenna part 110 or the second antenna part 120. Here, corresponding relations between each of the feeding portion 130 and the ground portion 140 and the first antenna part 110 or the second antenna part 120 may be changed depending on frequency bands of signals transmitted and received by the first antenna part 110 and the second antenna part 120 or forms of the first antenna part 110 and the second antenna part 120. In the case in which the second antenna part 120 has the dipole form, the ground portion 140 is disposed closer to the second antenna part 120 than to the first antenna part 110.

For example, the feeding portion 130 and/or the ground portion 140 are disposed at a central side of the tube shape, and are disposed adjacently to the second antenna part 120 respectively at an interval shorter than a dipole length of the second antenna part. Here, the dipole length is defined as a length from one end of the second antenna part 120 to the other end. Therefore, areas occupied by the feeding portion 130 and/or the ground portion 140 are reduced.

The coupling part 150 electrically connects the feeding portion 130 and the ground portion 140 to each other, and is electromagnetically coupled to the first antenna part 110 and/or the second antenna part 120. That is, the coupling part 150 is electromagnetically coupled to the first antenna part 110 and/or the second antenna part 120 to assist in formation of the radiation patterns, while serving as connection paths for the first antenna part 110, the second antenna part 120, the feeding portion 130, and the ground portion 140. Therefore, antenna performance and the radiation patterns are improved while reducing an entire volume of the antenna apparatus 100.

For example, the coupling part 150 includes a first coupling part 151 disposed to be electrically more proximate to the feeding portion 130 than to the ground portion 140, and a second coupling part 152 is disposed to be electrically more proximate to the ground portion 140 than to the feeding portion 130.

Positions and/or areas of the first coupling part 151 and the second coupling part 152 may be independently adjusted, and thus radiation characteristics of the first antenna part 110 and/or the second antenna part 120 may be precisely adjusted.

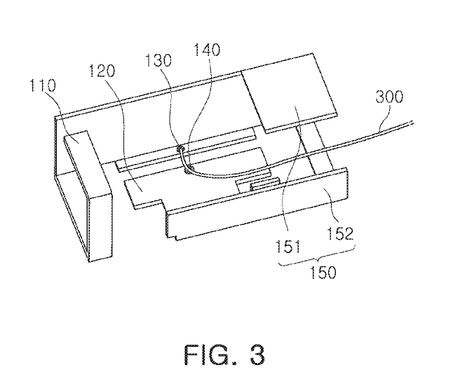

FIG. 3 is a view illustrating an example of a state in which the antenna apparatus of FIG. 2 is formed in a three-dimensional structure.

Referring to FIG. 3, the first antenna part 110 is folded to thereby have the aperture form, and the second antenna part 120 has side surfaces enclosed by the first coupling part 151 and the second coupling part 152. In addition, each of the feeding portion 130 and the ground portion 140 are connected to a cable 300.

That is, the first antenna part 110, the second antenna part 120, the feeding portion 130, the ground portion 140, and the coupling part 150 are formed in a structure folded from a planar state so as to be disposed on side surfaces of a hexahedral shape.

For example, the first antenna part 110 is disposed at one end of the hexahedral shape. Here, the first antenna part 110 is folded from a planar bar form to form an aperture. In addition, the first antenna part 110 transmits and receives signals in a lateral direction of the tube shape.

For example, the second antenna part 120 is disposed on one side surface of the hexahedral shape. Here, the second antenna part 120 has the dipole form. In addition, the second antenna part 120 transmits and receives signals in the length direction of the tube shape.

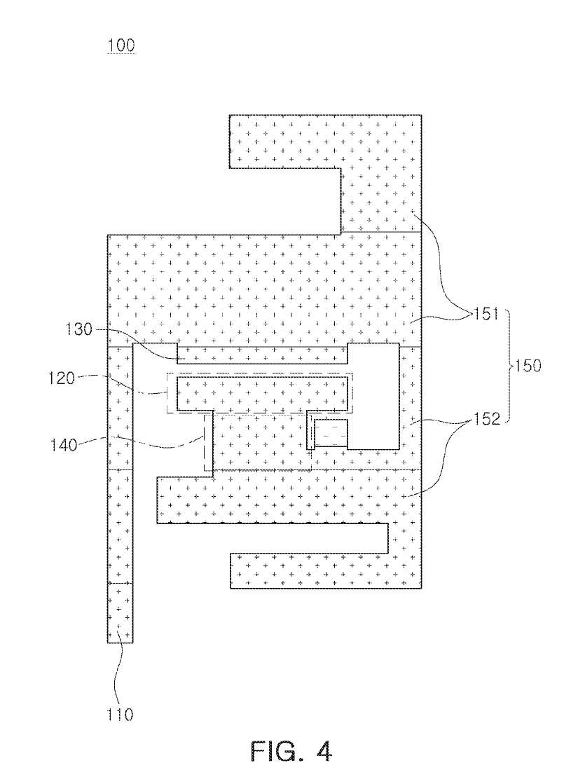

FIG. 4 is a view illustrating the antenna apparatus of FIG. 1 in more detail.

Referring to FIG. 4, the antenna apparatus 100 includes the first antenna part 110 and the second antenna part 120, and further includes a feeding portion 130, a ground portion 140, and a coupling part 150.

Areas of a first coupling part 151 and/or a second coupling part 152 are wider than those of the first coupling part 151 and/or the second coupling part 152 of the antenna apparatus illustrated in FIG. 2. The wider the areas of the first coupling part 151 and the second coupling part 152, the stronger the strength of the electromagnetic coupling to the first antenna part 110 and/or the second antenna part 120. For example, the larger the area of the first coupling part 151, the stronger the strength of the first coupling part 151 coupled to the radiation pattern of the second antenna part 120. For example, the larger the area of the second coupling part 152, the stronger the strength of the second coupling part 152 coupled to the radiation pattern of the first antenna part 120.

Generally, as areas of the first coupling part 151 and/or the second coupling part 152 become wide, performance and radiation characteristics of the first antenna part 110 and/or the second antenna part 120 are improved. There may be a trade-off between the areas of the coupling parts and the performance of the antenna parts.

Even though the areas of the coupling parts become wider, an entire volume of the antenna apparatus 100 is not changed substantially. Therefore, the first coupling part 151 and/or the second coupling part 152 are manufactured to cover most of the side surfaces of the tube shape. Therefore, antenna performance and the radiation patterns, as compared with the entire volume of the antenna apparatus 100, are optimized.

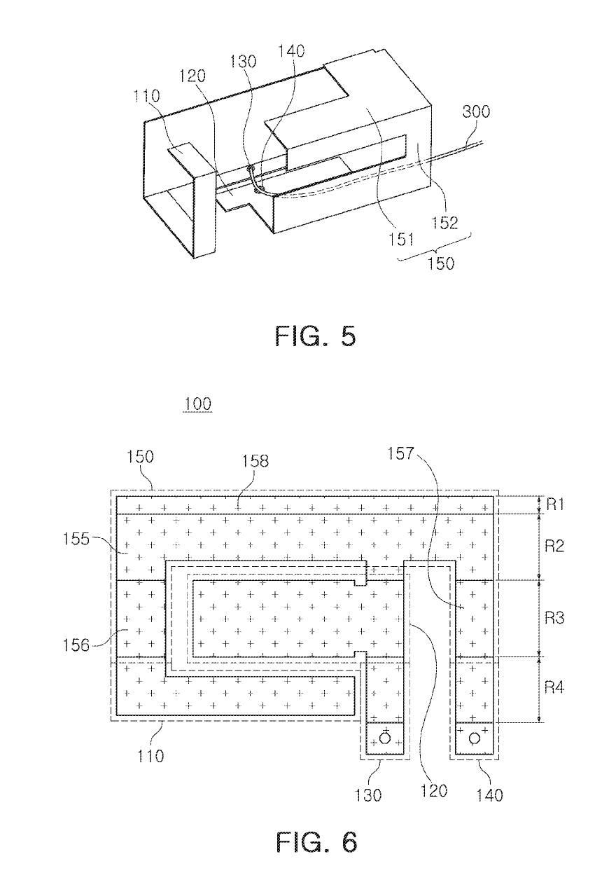

FIG. 5 is a view illustrating an example of a state in which the antenna apparatus of FIG. 4 is formed in a three-dimensional structure.

Referring to FIG. 5, the first antenna part 110 is folded to have the aperture form, and the second antenna part 120 has side surfaces enclosed by the first coupling part 151 and the second coupling part 152. In addition, each of the feeding portion 130 and the ground portion 140 are connected to a cable 300.

The first coupling part 151 and/or the second coupling part 152 are folded on the side surfaces of the tube shape, and cover a surface of the tube shape opposite to a surface of the tube shape on which the second antenna part 120 is disposed. Therefore, coupling for the second coupling part 152 becomes stronger.

Describing an example of a volume of the antenna apparatus illustrated in FIG. 5 in more detail, the volume is about 28 mm×11.6 mm×10.6 mm. The volume may be about 0.25 to about 0.5 times the volume of an external antenna according to the related art. That is, the volume of the antenna apparatus according to an embodiment is smaller than that of the external antenna.

FIG. 6 is a view illustrating the antenna apparatus of FIG. 1 in more detail.

Referring to FIG. 6, the antenna apparatus 100 according to an embodiment includes the first antenna part 110 and the second antenna part 120, a feeding portion 130, a ground portion 140, and a coupling part 150.

The antenna apparatus 100 is designed in relation to a first region R1, a second region R2, a third region R3, and a fourth region R4. Here, the first region R1 and the second region R2 are connected to each other while having a linear boundary therebetween, the second region R2 and the third region R3 are connected to each other while having a linear boundary therebetween, and the third region R3 and the fourth region R4 are connected to each other while having a linear boundary therebetween. For example, the linear boundaries are defined at portions folded in the antenna apparatus 100.

The first antenna part 110 is disposed in the fourth region R4.

The second antenna part 120 is disposed in the third region R3.

The feeding portion 130 is disposed in the fourth region R4 and is connected to the second antenna part 120. The feeding portion 130 is spaced apart from the first antenna part 110 and the ground portion 140.

The ground portion 140 is disposed in the fourth region R4. The ground portion 140 is connected to a second protrusion region 157 of the coupling part 150 disposed in the third region R3.

The coupling part 150 is disposed in the first to third regions R1 to R3, and is connected to the ground portion 140 and the first and second antenna parts 110 and 120.

The coupling part 150 is folded at the linear boundaries between the first to third regions R1 to R3 to enclose surfaces of a three-dimensional shape together with the first and second antenna parts 110 and 120. Therefore, in the antenna apparatus 100, the first and second antenna parts 110 and 120 transmit and receive signals omnidirectionally, and electromagnetic interference between the first and second antenna parts 110 and 120 is reduced.

The coupling part 150 includes a coupling body 155, a first protrusion region 156, a second protrusion region 157, and a support region 158.

The coupling body 155 is electromagnetically coupled to the first and second antenna parts 110 and 120 to reduce electromagnetic interference between the first and second antenna parts 110 and 120.

The first protrusion region 156 connects the coupling body 155 and the first antenna part 110 to each other. Electromagnetic characteristics of the first antenna part 110 are determined depending on a length of the first protrusion region 156.

The second protrusion region 157 connects the coupling body 155 and the ground portion 140 to each other. The second antenna part 120 is disposed between the first and second protrusion regions 156 and 157. Therefore, electromagnetic interference between the second antenna part 120 and the first antenna part 110 is reduced.

The second antenna part 120 is disposed between the first and second protrusion regions 156 and 157, such that the second antenna part 120 is spaced apart from the first antenna part 110 and the first and second protrusion regions 156 and 157 while being adjacent to the first antenna part 110 and the first and second protrusion regions 156 and 157. Electromagnetic characteristics of the second antenna part 120 are determined depending on a distance by which the second antenna part 120 is spaced apart from the first antenna part 110 and the first and second protrusion regions 156 and 157.

The support region 158 supports the antenna apparatus 100 when the antenna apparatus 100 is formed as a three-dimensional structure. Therefore, the first and second antenna parts 110 and 120 are spaced apart from a ground, such that a negative influence caused by the ground is reduced.

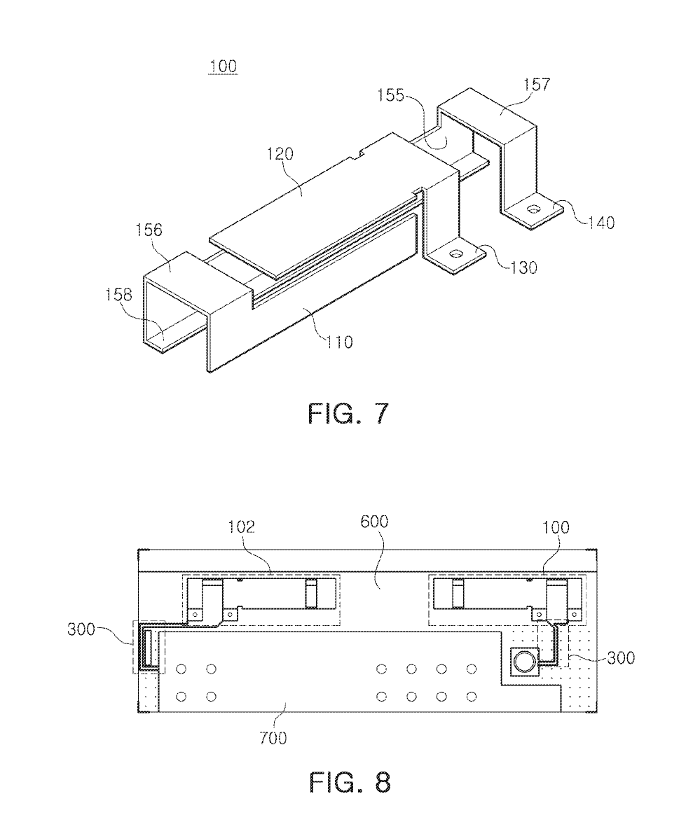

FIG. 7 is a view illustrating a state in which the antenna apparatus of FIG. 6 is formed as a three-dimensional structure.

Referring to FIG. 7, the antenna apparatus 100 according to an embodiment has a structure in which the first antenna part 110, the second antenna part 120, the feeding portion 130, the ground portion 140, the coupling body 155, the first protrusion region 156, the second protrusion region 157, and the support region 158 enclose surfaces of a three-dimensional shape.

The first antenna part 110 is perpendicular to the ground. Therefore, the first antenna part 110 concentrates radiation patterns in a horizontal direction.

The second antenna part 120 is parallel to the ground. Therefore, the second antenna part 120 concentrates radiation patterns in a vertical direction.

The first and second antenna parts 110 and 120 concentrate the radiation patterns in different directions to implement omni-directional signal transmission and reception of the antenna apparatus 100, and the feeding portion 130 and the ground portion 140 contact the ground to support the antenna apparatus 100.

The coupling body 155 is perpendicular to the ground. An area of the coupling body 155 is larger than that of the first antenna part 110. Since a vertical length of the coupling body 155 is greater than that of the first antenna part 110, the first antenna part 110 is spaced apart from the ground.

The first and second protrusion regions 156 and 157 are disposed on both sides of the second antenna part 120. Therefore, the second antenna part 120 further concentrates the radiation patterns in the vertical direction.

FIG. 8 is a view illustrating a substrate module in which the antenna apparatus of FIG. 7 is disposed.

Referring to FIG. 8, the substrate module according to an exemplary embodiment in the present disclosure includes a first antenna apparatus 101, a second antenna apparatus 102, cables 300, a substrate 600, and a metal structure 700.

Each of the first and second antenna apparatuses 101 and 102 includes the coupling part and the first and second antenna parts illustrated in FIGS. 1 through 7. In addition, the first and second antenna apparatuses 101 and 102 are disposed on the substrate 600 to be symmetrical to each other. Therefore, the first and second antenna apparatuses 101 and 102 transmit and receive signals in a multi-input multi-output (MIMO) scheme.

The cables 300 electrically connect one of the first and second antenna apparatuses 101 and 102 to the substrate 600, and provide high frequency signals or a ground to the first and second antenna apparatuses 101 and 102.

A metal layer is disposed in the substrate 600. The metal layer is electromagnetically coupled to the first and second antenna apparatuses 101 and 102. An electric potential of the metal layer is the same as that of the coupling parts of the first and second antenna apparatuses 101 and 102. Therefore, antenna performance of the first and second antenna apparatuses 101 and 102 is improved. For example, the substrate 600 is a printed circuit board (PCB).

The metal structure 700 is disposed on the substrate 600, and is electromagnetically coupled to the first and second antenna apparatuses 101 and 102. Antenna performance of the first and second antenna apparatuses 101 and 102 is changed depending on a distance between the metal structure 700 and the first or second antenna apparatus 101 or 102. Therefore, a position of the metal structure 700 is determined in consideration of performance of the first and second antenna apparatuses 101 and 102.

In a case in which the metal structure 700 is used for electromagnetic coupling to the first and second antenna apparatuses 101 and 102, an electric potential of the metal structure 700 is the same as that of the coupling parts of the first and second antenna apparatuses 101 and 102. Therefore, antenna performance of the first and second antenna apparatuses 101 and 102 is improved.

For example, the metal structure 700 is an integrated circuit (IC) transferring high frequency signals to the first and second antenna apparatuses 101 and 102. Therefore, the metal structure 700 is electrically connected to the first and second antenna apparatuses 101 and 102 through the cables 300.

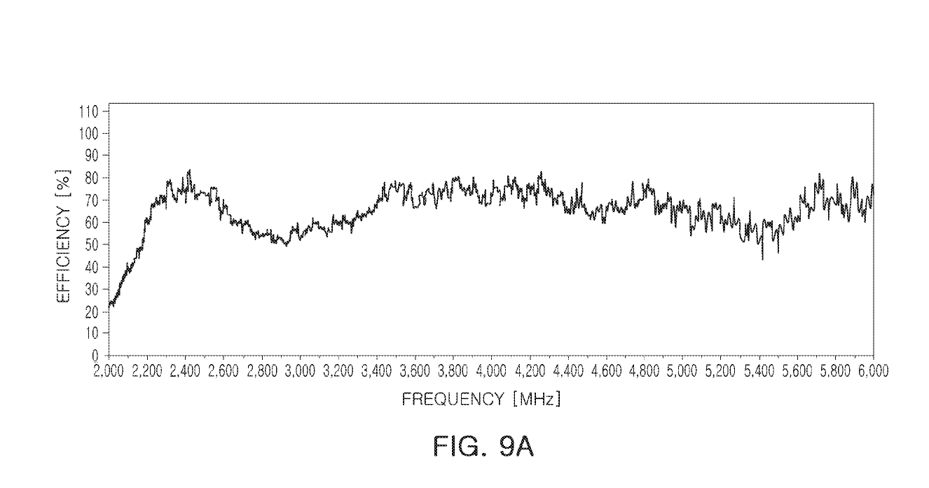

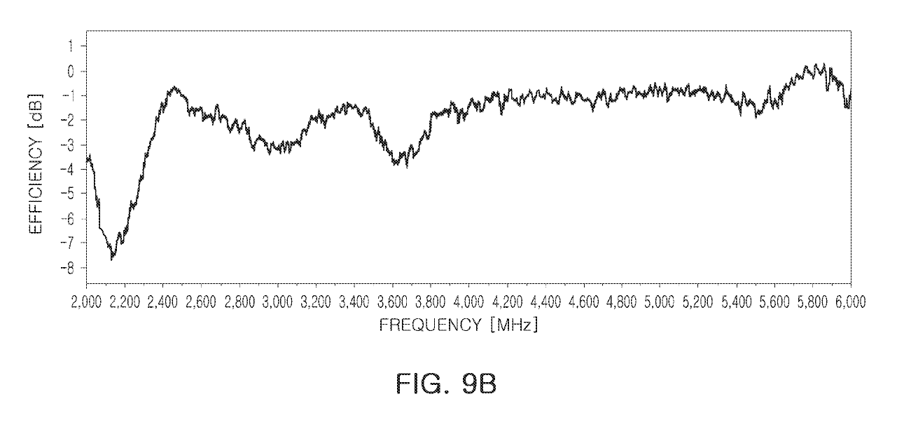

FIGS. 9A and 9B are examples of graphs illustrating efficiencies of the antenna apparatus according to an embodiment depending on frequencies.

FIG. 9A is a graph illustrating an efficiency of the antenna apparatus illustrated in FIG. 2 depending on a frequency, and FIG. 9B is a graph illustrating an efficiency of the antenna apparatus illustrated in FIG. 4 depending on a frequency.

The graphs illustrated in FIGS. 9A and 9B demonstrate that an efficiency of the antenna apparatus is higher in a band of about 2.4 GHz and a band of about 5 GHz. That is, average efficiencies of the antenna apparatus according to an embodiment in the band of about 2.4 GHz and the band of about 5 GHz are higher than those of the antenna apparatus according to the related art.

In FIG. 9A, an average efficiency of the antenna apparatus according to an embodiment in the band of about 2.4 GHz may be about 74.4%, and an average efficiency of the antenna apparatus according to an embodiment in the band of about 5 GHz may be about 61.9%.

In FIG. 9B, an average efficiency of the antenna apparatus according to an embodiment in the band of about 2.4 GHz is about 80.1%, and an average efficiency of the antenna apparatus according to an embodiment in the band of about 5 GHz is about 80.8%.

It should be appreciated through comparison between the graph of FIG. 9A and the graph of FIG. 9B that a radiation efficiency of the antenna apparatus of FIG. 4 has been further improved as compared to that of the antenna apparatus of FIG. 2.

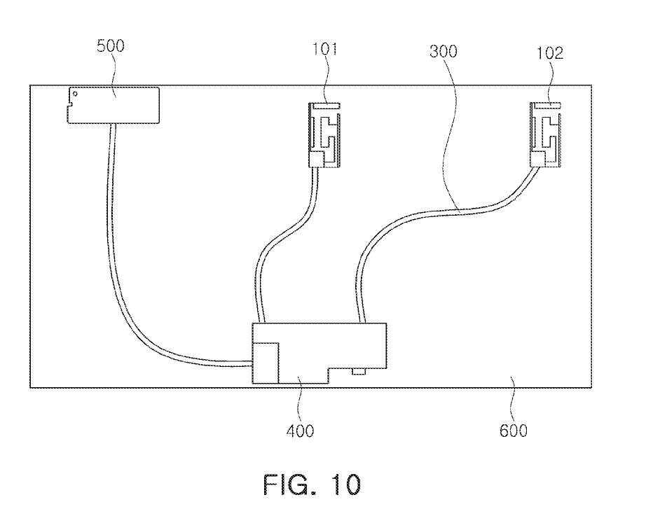

FIG. 10 is a view illustrating an operating environment of the antenna apparatus according to an embodiment.

Referring to FIG. 10, a first antenna apparatus 101, a second antenna apparatus 102, and a printed circuit board (PCB) antenna 500 are connected to cables 300, respectively. Here, the cables 300 are connected to a controller 400 generating and processing a range of frequencies including high frequency signals. The first antenna apparatus 101, the second antenna apparatus 102, the cables 300, the controller 400, and the PCB antenna 500 are disposed on a substrate 600.

For example, the first antenna apparatus 101, the second antenna apparatus 102, and the PCB antenna 500 are spaced apart from each other and transmit and receive signals in a multi-input multi-output (MIMO) scheme. In addition, the first antenna apparatus 101 and the second antenna apparatus 102 may transmit and receive signals in different frequency bands. Further, the first antenna apparatus 101 and the second antenna apparatus 102 may also transmit and receive signals in a plurality of frequency bands.

The antenna apparatuses 101 and 102 according to an embodiment are operated together with a heterogeneous antenna such as the PCB antenna 500 depending on an operating environment.

The substrate 600 may be included in an electronic device. That is, the antenna apparatuses 101 and 102 according to an embodiment are included in the electronic device to transmit and receive signals for communications of the electronic device.

As set forth above, in the antenna apparatus according to an embodiment, signals may be transmitted and received omni-directionally, and the volume occupied by the antennas is reduced.

In addition, in the antenna apparatus according to an embodiment, signals in a plurality of frequency bands are transmitted and received, and interference of one of the signals in the plurality of frequency bands with another thereof is reduced.

The apparatuses, units, modules, devices, and other components (e.g., controller 400) illustrated in FIG. 10 that perform the operations described herein are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

As a non-exhaustive example only, an electronic device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus comprising:
a first antenna part configured to transmit and receive signals in a first frequency band;
a coupling part connected to the first antenna part; and
a second antenna part connected to the coupling part and configured to transmit and receive signals in a second frequency band different from the first frequency band,
wherein the second antenna part encloses surfaces of a three-dimensional shape together with the first antenna part and the coupling part.

2. The antenna apparatus of claim 1, wherein the second antenna part is disposed on one surface of the three-dimensional shape, and
the coupling part encloses one surface of the three-dimensional shape, two surfaces of the three-dimensional shape adjacent to the one surface, and a surface of the three-dimensional shape opposing the one surface.

3. The antenna apparatus of claim 2, wherein the first antenna part encloses the one surface of the three-dimensional shape, one of the two surfaces of the three-dimensional shape adjacent to the one surface, and the surface of the three-dimensional shape opposing the one surface.

4. The antenna apparatus of claim 2, wherein the first antenna part is disposed on one of the two surfaces of the three-dimensional shape adjacent to the one surface and has an area smaller than that of the coupling part.

5. The antenna apparatus of claim 1, further comprising:
a feeding portion configured to provide signals to the first antenna part and the second antenna part; and
a ground portion configured to provide a ground to the first antenna part and the second antenna part.

6. The antenna apparatus of claim 5, wherein one of the feeding portion and the ground portion contacts the second antenna part, and the other thereof contacts the coupling part.

7. A substrate module comprising:
a substrate; and
an antenna apparatus disposed on the substrate,
wherein the antenna apparatus includes:
a coupling part having a folded shape to enclose surfaces of a three-dimensional shape and contacting the substrate;
a first antenna part connected to the coupling part, spaced apart from the substrate, and configured to transmit and receive signals in a first frequency band; and
a second antenna part connected to the coupling part, spaced apart from the substrate, and configured to transmit and receive signals in a second frequency band different from the first frequency band.

8. The substrate module of claim 7, wherein the first antenna part is perpendicular to the substrate, and
the second antenna part is in parallel with the substrate.

9. The substrate module of claim 7, wherein the coupling part has first and second protrusion regions,
the first protrusion region is connected to the first antenna part, and
the second protrusion region is connected to a ground portion.

10. The substrate module of claim 9, wherein the second antenna part is disposed between the first and second protrusion regions, and
a feeding portion is connected to the second antenna part.

11. The substrate module of claim 7, wherein the antenna apparatus further includes:
a feeding portion configured to provide signals to the first antenna part and the second antenna part; and
a ground portion configured to provide a ground to the first antenna part and the second antenna part,
one of the feeding portion and the ground portion contacting the second antenna part and the other thereof contacting the coupling part.

12. The substrate module of claim 11, wherein the feeding portion and the ground portion are electrically connected to the substrate, and
the substrate provides the signals and the ground to the first and second antenna parts.

13. The substrate module of claim 7, wherein the substrate includes a metal layer spaced apart from the antenna apparatus, and
an electric potential of the metal layer is the same as that of the coupling part.

14. The substrate module of claim 7, further comprising a metal structure disposed on the substrate,
wherein an electric potential of the metal structure is the same as that of the coupling part.

15. The substrate module of claim 7, further comprising a second antenna apparatus disposed on the substrate,
wherein the second antenna apparatus has a structure symmetrical to the antenna apparatus.

16. A multi-band antenna comprising:
a substantially planar conductive member configured to be folded on an axis, the planar conductive member comprising:
a coupling part disposed in first to third regions;
a first antenna part disposed in a fourth region and connected to the coupling part; and
a second antenna part disposed in the third region and connected to the coupling part,
wherein the first region and the second region are connected to each other while having a linear boundary therebetween,
the second region and the third region are connected to each other while having a linear boundary therebetween, and
the third region and the fourth region are connected to each other while having a linear boundary therebetween.

17. The multi-band antenna of claim 16, wherein the substantially planar conductive member is configured to be folded on three substantially parallel axes to form a 3-dimensional antenna member.

18. The multi-band antenna of claim 16, wherein the second antenna part is configured to radiate in a substantially axial direction, the first antenna part is configured to radiate in a lateral direction, and the first operational frequency is different from the second operational frequency.

19. The multi-band antenna of claim 16, wherein the coupling part configured to electrically connect the first antenna part with the second antenna part and to electromagnetically couple with the first antenna part and/or the second antenna part to collectively generate a radiation pattern.
